(19) United States
(12) Patent Application Publication
(10) Pub. No.: US 2024/0360930 A1
(43) Pub. Date: Oct. 31, 2024

(54) LIGATURE RESISTANT QUICK DISCONNECT WITH POSITIVE SHUTOFF

(71) Applicant: Willoughby Industries Inc., Indianapolis, IN (US)

(72) Inventor: Timothy Brandli, Zionsville, IN (US)

(73) Assignee: Willoughby Industries Inc., Indianapolis, IN (US)

(21) Appl. No.: 18/306,643

(22) Filed: Apr. 25, 2023

(51) Int. Cl. F16L 29/00; E03C 1/04; F16L 15/08

(52) U.S. Cl. CPC F16L 29/007; E03C 1/0408; F16L 15/08; E03C 2001/026

(57) ABSTRACT

A ligature resistant quick disconnect assembly includes a base having a base inlet and a base outlet allowing for the flow of water through the base. A nozzle is connected to the base at the base outlet, and a positive shutoff valve is positioned within a nozzle valve opening defined in the nozzle. An insert is removably connectable to the nozzle. When the insert is not connected to the nozzle, the positive shutoff valve is arranged in a closed configuration that does not allow water to pass through the nozzle. When the insert is inserted into the nozzle, the positive shutoff valve is moved to an open configuration that allows the flow of water through the nozzle and to a hose attached to the insert.

### BACKGROUND

Ligature resistant products are important features for rooms in healthcare facilities and other environments where there is a danger that an occupant may accidentally injury themselves or try to cause harm to themselves or to others. In particular, surfaces where an occupant may drape or wrap a flexible material, such as clothing, may act as a ligature point and present a risk of ligature to the occupant. In some instances, a quick disconnect connection points for plumbing devices such as handheld shower heads may present such a risk to an occupant by presenting ligature points. Therefore, consideration should be given to reducing such a risk. Thus, improvement in this field is desired.

### SUMMARY

In certain embodiments, a quick disconnect assembly may include a base that includes a base inlet and a base outlet. The base outlet may include a base outlet threaded surface for connecting the base to a nozzle. The nozzle may include a nozzle valve opening and a nozzle insert opening and a nozzle intermediate opening positioned between the nozzle valve opening and the nozzle insert opening. The nozzle may also include a nozzle connection portion that threadedly connects to the base outlet threaded surface when the nozzle is connected to the base. In some instances, the nozzle includes nozzle shoulders. The nozzle shoulders may be flush with respect to a surface of the base when the nozzle is connected to the base.

A positive shutoff valve may be positioned within the nozzle valve opening and an insert may be removably connectable to the nozzle. The positive shutoff valve may be translatable within the nozzle valve opening so that the positive shutoff valve may be moved between an open configuration and a closed configuration. Typically, the positive shutoff valve is biased into the closed configuration so that fluid does not pass through the base and the nozzle when the insert is not attached to the nozzle. The positive shutoff valve may be positioned in the open configuration when the insert is connected to the nozzle, and the positive shutoff valve may be positioned in the closed configuration when the insert is not connected to the nozzle. In some embodiments, positive shutoff valve blocks the nozzle intermediate opening when the positive shutoff valve is in the closed configuration and wherein the positive shutoff valve is spaced from the nozzle intermediate opening when the positive shutoff valve is in the open configuration.

In some embodiments, at least a portion of the insert is positioned within the nozzle insert opening of the nozzle when the insert is connected to the nozzle. In some instances, inserting the insert into the nozzle insert opening may cause translation of the positive shutoff valve within the nozzle valve opening.

In some embodiments, the insert may include a locking tab. The locking tab may be positioned within a locking recess in the nozzle insert opening when the insert is attached to the nozzle. The insert may also include an insert projection, and the insert projection may be in contact with the positive shutoff valve when the insert is connected to the nozzle.

In some aspects, the quick disconnect assembly may also include a hose including a handheld shower head. The hose may be connected to the insert. In some instances, the quick disconnect assembly may include rounded corners and smooth surfaces so as to reduce the possibility of ligature points on the quick disconnect assembly.

A method of assembling a ligature resistant quick disconnect assembly may comprise attaching a nozzle to a base. A positive shutoff valve may be positioned in a nozzle valve opening defined in the nozzle, and the base may include a base inlet and a base outlet. An insert may be attached to the nozzle, and the insert may include an accessory attachment section. The insert may contact the positive shut off valve when the insert is attached to the nozzle. Contact between the insert and the positive shut off valve may cause the positive shutoff valve to move within the nozzle valve opening from a closed configuration to an open configuration. In some embodiments, a hose may be attached to the insert at the accessory attachment section of the insert. The hose may include a handheld shower head.

Further forms, objects, features, aspects, benefits, advantages, and embodiments of the present invention will become apparent from a detailed description and drawings provided herewith.

### BRIEF DESCRIPTION OF THE DRAWINGS

FIG. 1 is a side view of a quick disconnect assembly connected to a hose.

FIG. 2 is an exploded side view of the quick disconnect assembly of FIG. 1.

FIG. 3 is a perspective view of a base of the quick disconnect assembly of FIG. 1.

FIG. 4 is a cross-sectional side view of the base of FIG. 3.

FIG. 5. is a perspective view of a positive shut off valve of the quick disconnect assembly of FIG. 1.

FIG. 6 is a perspective view of a nozzle of the quick disconnect assembly of FIG. 1.

FIG. 7 is a cross-sectional side view of the nozzle of FIG. 6.

FIG. 8 is a perspective view of an insert of the quick disconnect assembly of FIG. 1.

FIG. 9 is a cross-sectional side view of the insert of FIG. 8.

FIG. 10 is a cross-sectional side view of the nozzle attached to the base of the quick disconnect assembly of FIG. 1 with the positive shut off valve positioned in a closed configuration.

FIG. 11 is a cross-sectional side view of the quick disconnect assembly of FIG. 1 with the insert attached to the nozzle and the positive shut off valve in an open configuration.

FIG. 12 is a side view of the quick disconnect assembly of FIG. 1 with a connected handheld shower head.

### DETAILED DESCRIPTION

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

Spatially relative terms such as “lower”, “upper”, “under”, “over”, “above” and the like may be used to describe and element's and/or feature's relationship to another element(s) or feature(s), for example as depicted in the Figures. It will be understood that the spatially relative terms are intended to encompass different operations of the system, device or component in use in addition to the orientation described or depicted in the Figures. For example, if a device or component as depicted in the Figures is inverted, an element that is shown and described as “upper” would then be oriented as “lower”.

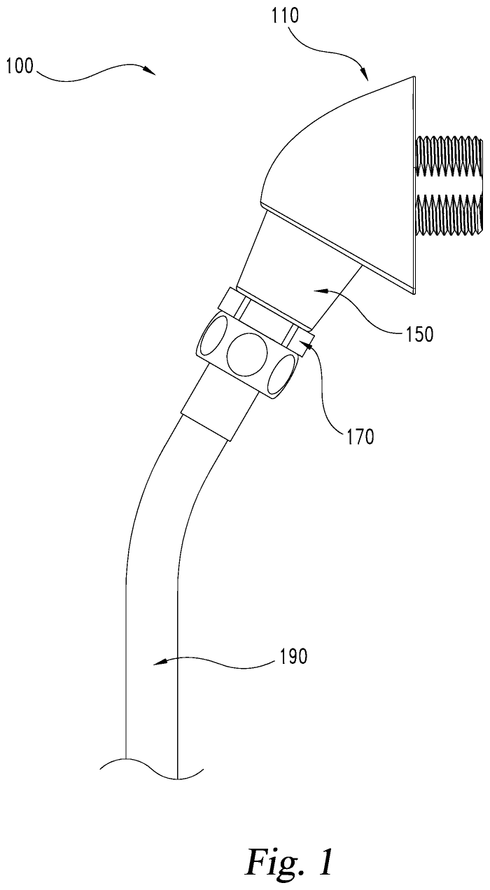

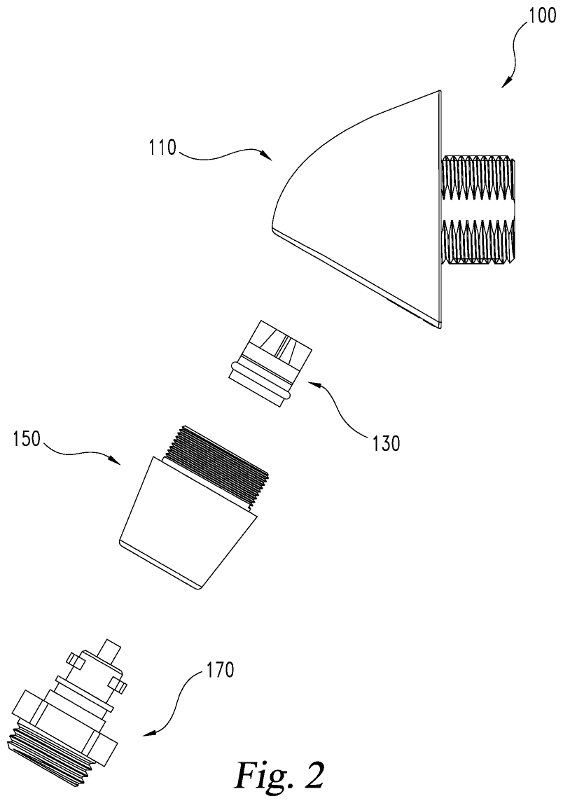

A side view of a quick disconnect assembly 100 is illustrated in FIG. 1, and an exploded view of the quick disconnect assembly 100 is shown in FIG. 2. The quick disconnect assembly 100 includes a base 110, a positive shutoff valve 130 (see FIG. 2), a nozzle 150, and an insert 170. In the embodiment shown in FIG. 1, a hose 190 is connected to the quick disconnect assembly 100. The positive shutoff valve 130 fits within the nozzle 150 and a portion of the insert 170 is also positioned within the nozzle 150 when the quick disconnect assembly 100 is assembled. The components of the quick disconnect assembly 100 are designed to have smooth surfaces and rounded corners to assist in preventing ligature points on the quick disconnect assembly 100.

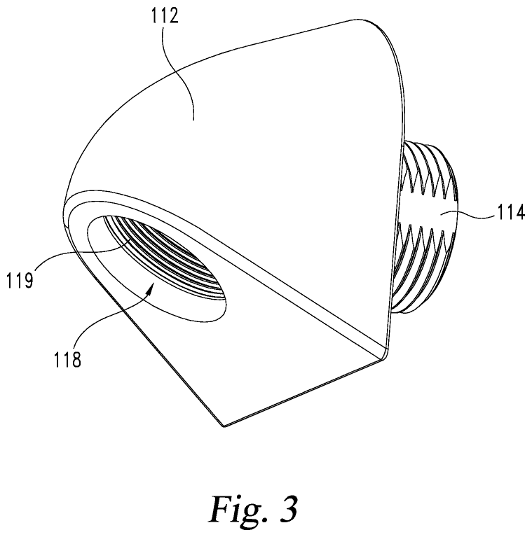

A perspective view of the base 110 of the quick disconnect assembly 100 is shown in FIG. 3. The base 110 includes a base body 112 and a connection section 114 that extends from the base body 112. The base body 112 includes rounded corners and smooth surfaces that assist to reduce ligature points on the quick disconnect assembly 100. In the embodiment shown, the connection section 114 is threaded and configured to be coupled to a water spigot or any other suitable water source. The connection section defines a base inlet 115. The base inlet 115 may include an inlet threaded surface 116 that is capable of receiving a threaded connector.

The base inlet 115 is in fluid communication with an intermediate channel 117 that is defined within the base body 112. The intermediate channel 117 is in fluid communication with a base outlet 118 that is defined by the base body 112. The base outlet 118 may include a base outlet threaded surface 119 configured to allow the nozzle 150 to be threadedly attached to the base 110. The base 110 may be in fluid communication with an exterior fluid source, so that the exterior fluid enters the base 110 at the base inlet 115 and the fluid flows from the base inlet 115, through the intermediate channel 117, and out of the base 110 through the base outlet 118.

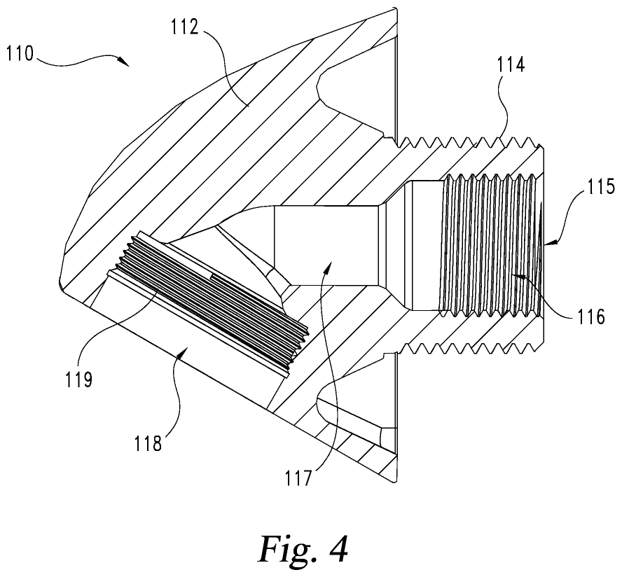

In some embodiments, as shown in FIG. 4, the base inlet 115 may be aligned with the intermediate channel 117. The base outlet 118 may be positioned at an oblique angle with respect to the intermediate channel 117, allowing the base outlet to be directed at least partially downward to direct water flowing through the base 110 in a downward direction, toward a user of the quick disconnect assembly 100.

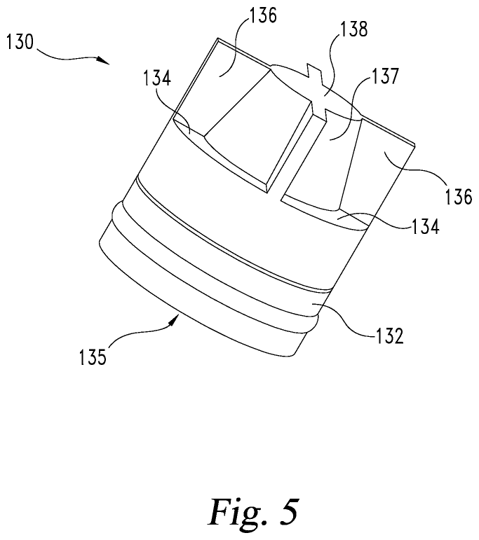

The positive shut off valve 130 is shown in more detail in FIG. 5. The positive shutoff valve 130 includes a valve base 132 and a valve recess 135 defined through a portion of the valve base 132. Valve shoulders 134 are positioned at an end of the valve base 132. A valve head 137 extends from the valve base 132 at the valve shoulders 134. In the embodiment shown, the valve head 137 is partially conical, but the valve head 137 may be any other suitable shape as desired. Fins 136 extend from the valve head 137 and are supported at one end by the valve base 132. A valve end surface 138 is defined between the valve fins 136 at an end of the valve head 137.

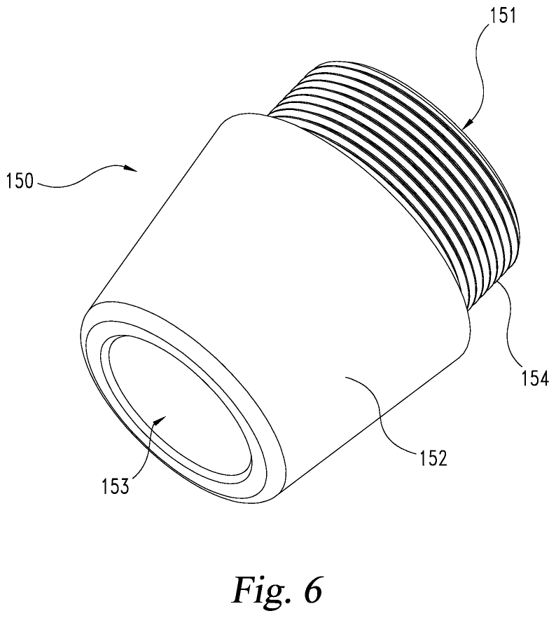

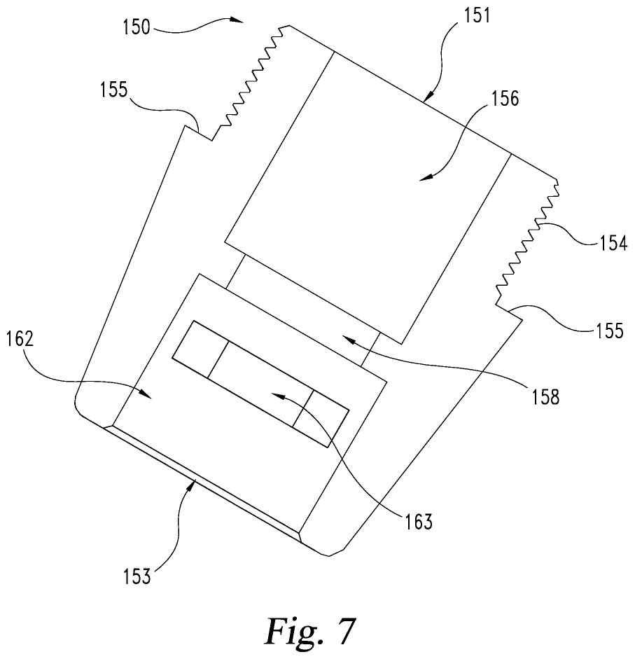

The nozzle 150 is illustrated in FIGS. 6-7. The nozzle 150 defines a nozzle inlet 151 and a nozzle outlet 153 and includes a nozzle body 152 and a nozzle connection portion 154. In the embodiment shown, the nozzle body 152 has a width that is greater than the width of the nozzle connection portion 154. Nozzle shoulders 155 are formed at the transition between the nozzle body 152 and the nozzle connection portion 154. In the embodiment shown, the nozzle shoulders 155 extend generally perpendicularly with respect to the sides of the nozzle connection portion 154.

The nozzle connection portion 154 of nozzle 150 is configured to fit within the base outlet 118 to allow the nozzle 150 to be removably connected to the base 110. In the embodiment shown, the nozzle connection portion 154 has a threaded exterior surface that mates with outlet threaded surface 119 of the base 110 to connect the nozzle 150 to the base 110.

A nozzle valve opening 156 is defined within the nozzle 150 and extends through an inlet of the nozzle 150 defined through the nozzle connection portion 154. The nozzle valve opening 156 is configured to receive and house the positive shutoff valve 130. A nozzle intermediate opening 158 is in fluid communication with the nozzle valve opening 156. In the embodiment shown, the nozzle intermediate opening 158 has a width that is less than the width of the nozzle valve opening 156.

A nozzle insert opening 162 is also in fluid communication with the nozzle intermediate opening 158, and, in the embodiment shown, the nozzle insert opening 162 is in direct fluid communication with the nozzle intermediate opening 158. In this embodiment, the nozzle insert opening 162 has a width that is greater than the nozzle intermediate opening 158. The nozzle insert opening 162 extends through an outlet of the nozzle 150 defined through the nozzle body 152. A locking recess 163 is defined within the nozzle insert opening 162.

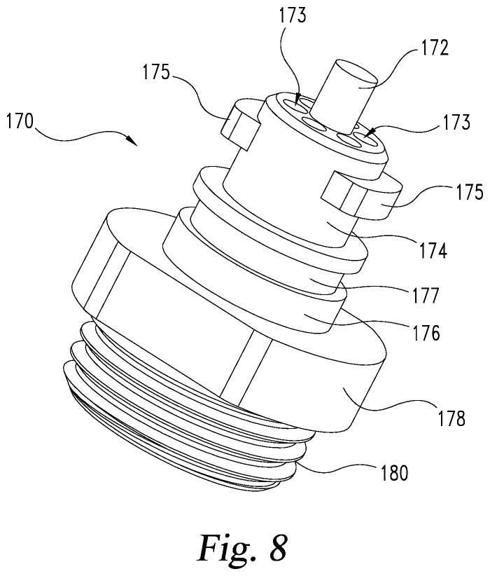

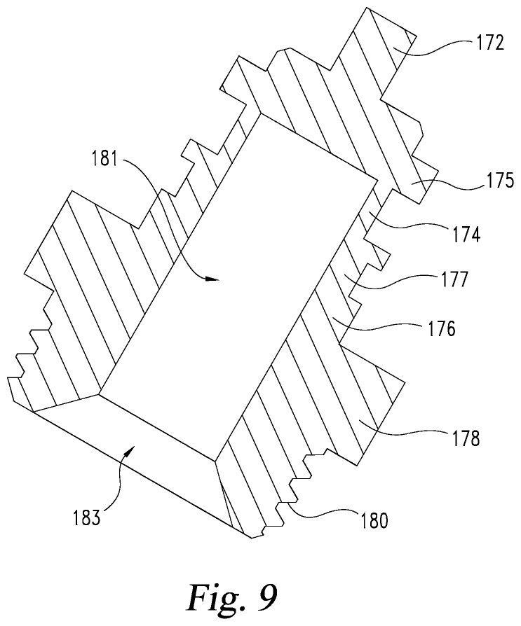

The insert 170 is shown in more detail in FIGS. 8-9. The insert 170 includes an insert projection 172 that extends from a locking section 174. A pair of locking tabs 175 extend from the locking section 174. Although there are two locking tabs 175 shown on insert 170 in this embodiment, in other embodiments, there may be only one locking tabs 175 or there may be three or more locking tabs 175. The locking section 174 also includes one or more insert inlets 173 that extend through an outer surface of the locking section 174, allowing fluid to flow through the insert 170. In the embodiment shown, the insert inlets 173 are circular in shape; however, in other embodiments the shape or the number of insert inlets 173 may be modified as desired.

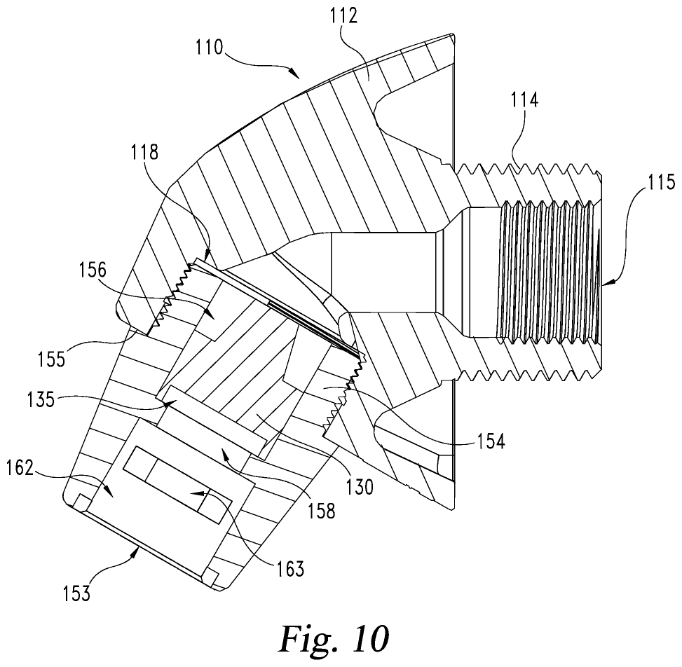

The locking section 174 extends from an insert body section 176. A seal seat 177 is defined within the insert body section 176 and is configured to receive a seal 186 that may assist to prevent leakage of water at the interface between the insert 170 and the nozzle 150 when the insert 170 is connected to the nozzle 150 (see FIG. 10). In the embodiment shown, the insert body section 176 has a width that is greater than a width of the locking section 174.

The insert body section 176 extends from one side of an insert base 178. The insert base 178 has a width that is greater than the width of the insert body section. An accessory attachment section 180 extends from the opposite side of the insert base 178 as the insert body section 176. The accessory attachment section 180 has a threaded exterior surface for mating with a complimentary threaded surface on a device such as a hose 190.

An insert channel section 181 is defined within the insert 170. The insert channel section 181 is in fluid communication with the insert inlets 173 and with an insert outlet section 183 that is defined within the accessory attachment section 180 of the insert 170. The insert outlet section 183 may act as an outlet for a fluid passing through the quick disconnect assembly 100. In some examples, the insert outlet section 183 may be in direct fluid communication with hose 190 when hose 190 is connected to the quick disconnect assembly 100. In other embodiments where hose 190 is not connected to the quick disconnect assembly 100, water or any other fluid flowing through the quick disconnect assembly may flow to an exterior environment with respect to the quick disconnect assembly 100 through the insert outlet section 183.

A cross-sectional view of the nozzle 150 attached to the base 110 of the quick disconnect assembly 100 is illustrated in FIG. 10. As shown, the positive shutoff valve 130 is positioned within the nozzle valve opening 156 defined in the nozzle 150. The positive shutoff valve 130 fits within the nozzle valve opening 156 so that the positive shutoff valve 130 may translate longitudinally within the nozzle valve opening 156. When the positive shutoff valve 130 is positioned within the nozzle valve opening 156, and the insert 170 is not attached to the nozzle 150, the positive shutoff valve 130 is biased into a closed configuration that prevents the flow of fluid through the nozzle 150.

The nozzle connection portion 154 of the nozzle 150 is inserted within the base 110 at the base outlet 118 to attach the nozzle 150 to the base 110. In the embodiment shown, the threaded exterior surface of the nozzle connection portion 154 is threadedly connected to the base outlet threaded surface 119 within the base outlet 118. However, in other embodiments, the nozzle 150 may be connected to the base 110 by other attachment methods, such as a friction fit, a snap fit system, a detent system, or any other suitable method. Additionally, the nozzle shoulders 155 are positioned flush against the surface of the base body 112 when the nozzle 150 is connected to the base 110. This helps to reduce the possibility of seams and possible ligature points around at the junction between the nozzle 150 and the base 110 when the nozzle 150 is attached to the base 110.

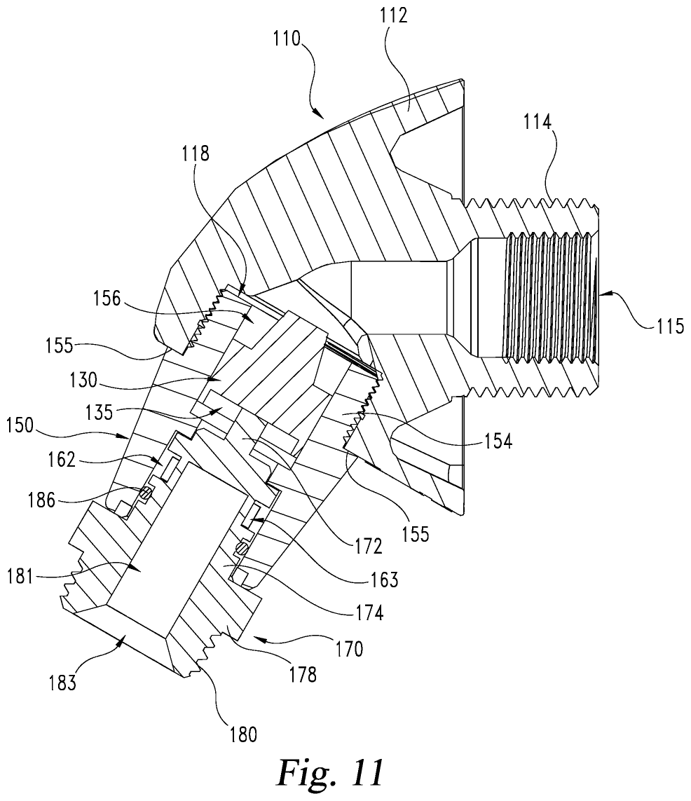

A cross-sectional view of the quick disconnect assembly 100 in an assembled configuration with the insert 170 attached to the nozzle 150 is shown in FIG. 11. Attaching the insert 170 to the nozzle 150 causes the insert to contact the positive shut off valve 130 and move the positive shut off valve 130 into an open configuration. When the positive shut off valve 130 is positioned in the open configuration, fluid is allowed to flow through the nozzle and through the insert 170 and either directly out of the insert 170 or into an accessory attached to the insert 170.

The insert 170 is connected to the nozzle 150 so that the locking section 174 and the insert body section 176 of the insert 170 are fit within the nozzle insert opening 162 of the nozzle 150. When the locking section 174 of the insert 170 is positioned within the nozzle insert opening 162, the locking tabs 175 positioned on the insert body section 176 may fit within a respective locking recess 163 defined within the nozzle insert opening 162 to help retain the insert 170 to the nozzle 150.

Additionally, when the insert 170 is attached to the nozzle 150, the insert projection 172 extends into the nozzle valve opening 156 and contacts the positive shutoff valve 130. In the embodiment shown, the insert projection 172 extends within the valve recess 135 to contact the positive shutoff valve 130. The insert projection 172 causes the positive shutoff valve 130 to translate within the nozzle valve opening 156 in a direction toward the inlet of the nozzle 150 from the closed configuration to the open configuration.

When the positive shut off valve 130 of the quick disconnect assembly 100 is in the open configuration, an exterior fluid enters the quick disconnect assembly 100 at the base 110 through the base inlet 115 and exits the base at the base outlet 118. The base outlet 118 is in fluid communication with the nozzle valve opening 156 of the nozzle 150, so that the fluid flows from the base into the nozzle 150. If the positive shut off valve 130 is in the open configuration, the fluid flows from the nozzle valve opening 156 into the nozzle intermediate opening 158 and then into the nozzle insert opening 162. The fluid exits the nozzle 150 through the nozzle outlet 153. The nozzle 150 is in fluid communication with the insert 170 when the insert 170 is connected to the nozzle 150. Fluid flows from the nozzle outlet 153 into the insert channel section 181 and to the insert outlet section 183. The fluid may exit the quick disconnect assembly 100 from the insert outlet section 183 and into an external accessory such as hose 190 or to the environment external to the quick disconnect assembly if no external accessory is attached to the insert 170.

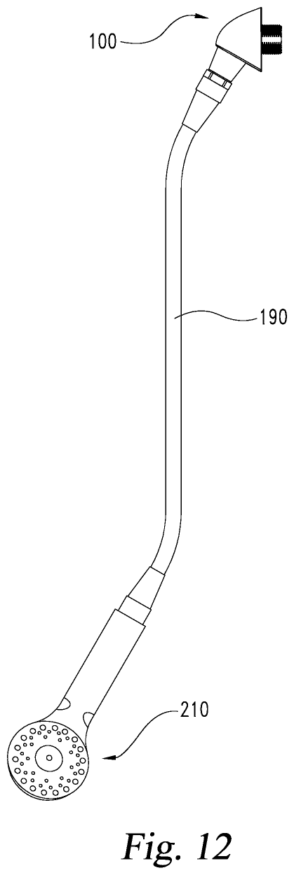

As shown in FIG. 12, in one example, the external accessory may be a hose 190 that is connected to the quick disconnect assembly 100 at the accessory attachment section 180. In some embodiments, the hose 190 may be threadedly connected to the quick disconnect assembly 100. In some embodiments, the hose 190 may be a portion of a handheld shower head 210 that allows a user to easily manipulate the direction and/or spray of water from the hose 190. The handheld shower head 210 may have rounded and smoothed surfaces that help reduce ligature points on shower head.

A method of assembling the quick disconnect assembly 100 includes attaching the nozzle 150 to the base 110 as shown in FIG. 10. The positive shutoff valve 130 is positioned in the nozzle valve opening 156 of the nozzle 150 and biased into the closed configuration so that fluid does not pass through the nozzle 150. The insert 170 is then attached to the nozzle 150. When the insert 170 is attached to the nozzle 150 the insert 170 contacts the positive shut off valve 130 and causes the positive shutoff valve 130 to translate within the nozzle valve opening 156 from the closed configuration to the open configuration, allowing fluid to flow through the nozzle 150 and the insert 170 and either out of the insert 170 or through to an accessory that is attached to the insert 170.

In some embodiments, the insert 170 may first be attached to the nozzle 150 and move the positive shut off valve 130 into the open configuration. The nozzle 150 may then be attached to the base 110 to place the insert 170 and the nozzle 150 into fluid communication with the base 110.

The uses of the terms “a” and “an” and “the” and similar references herein (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the products or methods defined by the claims.

While embodiments of the disclosure have been illustrated and described in detail in the drawings and foregoing description, the same is to be considered as illustrative and not restrictive in character, it being understood that only some embodiments have been shown and described and that all changes and modifications that come within the spirit of the disclosures herein are desired to be protected.

1. A ligature resistant quick disconnect assembly comprising:
a base, wherein the base includes a base inlet and a base outlet;
a nozzle including a nozzle valve opening and a nozzle insert opening, wherein said nozzle connects to said base at said base outlet;
a positive shutoff valve, wherein said positive shutoff valve is positioned within said nozzle valve opening;
an insert, wherein said insert is removably connectable to said nozzle,
wherein said positive shutoff valve is positioned in an open configuration when said insert is connected to said nozzle; and
wherein said positive shutoff valve is positioned in a closed configuration when said insert is not connected to said nozzle.

2. The ligature resistant quick disconnect assembly of claim 1, wherein said positive shutoff valve is translatable within said nozzle valve opening.

3. The ligature resistant quick disconnect assembly of claim 2,
wherein said insert is configured to cause translation of said positive shutoff valve within said nozzle valve opening when said insert is connected to said nozzle.

4. The ligature resistant quick disconnect assembly of claim 1, further comprising:
a hose including a handheld shower head; and
wherein said hose is connected to said insert.

5. The ligature resistant quick disconnect assembly of claim 1, wherein at least a portion of said insert is positioned within said nozzle insert opening of said nozzle when said insert is connected to said nozzle.

6. The ligature resistant quick disconnect assembly of claim 5, wherein said insert includes a locking tab, and wherein said locking tab is positioned within a locking recess in said nozzle insert opening when said insert is attached to said nozzle.

7. The ligature resistant quick disconnect assembly of claim 1, wherein said insert includes an insert projection, and wherein said insert projection is in contact with said positive shutoff valve when said insert is connected to said nozzle.

8. The ligature resistant quick disconnect assembly of claim 1, wherein said base outlet includes a base outlet threaded surface.

9. The ligature resistant quick disconnect assembly of claim 8, wherein said nozzle includes a nozzle connection portion that threadedly connects to the base outlet threaded surface when said nozzle is connected to said base.

10. The ligature resistant quick disconnect assembly of claim 1, wherein said nozzle includes a nozzle intermediate opening.

11. The ligature resistant quick disconnect assembly of claim 10, wherein said positive shutoff valve blocks said nozzle intermediate opening when said positive shutoff valve is in said closed configuration and wherein said positive shutoff valve is spaced from said nozzle intermediate opening when said positive shutoff valve is in said open configuration.

12. The ligature resistant quick disconnect assembly of claim 1, wherein said nozzle includes nozzle shoulders, and wherein said nozzle shoulders are flush with respect to a surface of said base when said nozzle is connected to said base.

13. A method of assembling a ligature resistant quick disconnect assembly, comprising:
attaching a nozzle to a base, wherein a positive shutoff valve is positioned in a nozzle valve opening defined in said nozzle, and wherein said base includes a base inlet and a base outlet;
attaching an insert to said nozzle, wherein said insert includes an accessory attachment section; and
wherein said insert contacts said positive shut off valve when said insert is attached to said nozzle and causes said positive shutoff valve to move within said nozzle valve opening from a closed configuration to an open configuration.

14. The method of claim 13, further comprising:
inserting said positive shutoff valve within said nozzle valve opening of said nozzle.

15. The method of claim 13, further comprising:
attaching a hose to said insert at said accessory attachment section of said insert.

16. The method of claim 15, wherein said hose includes a handheld shower head.

17. The method of claim 13, wherein said insert includes a locking tab, and wherein said locking tab is fit within a locking recess of said nozzle when said insert is attached to said nozzle.

18. The method of claim 13, wherein said insert includes an insert projection, and wherein said insert projection is in contact with said positive shutoff valve when said insert is connected to said nozzle.

19. The method of claim 13, wherein said positive shut off valve is spaced from a nozzle intermediate opening when said positive shutoff valve is moved into said open configuration by said insert.

20. The method of claim 13, wherein said positive shut off valve is biased in the closed configuration when said insert is not attached to said nozzle, and wherein said positive shutoff valve blocks said nozzle intermediate opening when said positive shutoff valve is in said closed configuration.

21. A ligature resistant quick disconnect assembly comprising:
a base, wherein the base includes a base inlet and a base outlet;
a nozzle including a nozzle inlet and a nozzle outlet and defining a nozzle insert opening between said nozzle inlet and nozzle outlet, wherein a first locking recess is defined in said nozzle insert opening, and wherein said nozzle connects to said base at said base outlet;
a valve positioned between said base inlet and said nozzle outlet;
an insert including an insert locking section, a first locking tab extending radially outward from said insert locking section, and an insert outlet, wherein said insert is removably connectable to said nozzle;
wherein said first locking tab is positioned in said first locking recess when said insert is connected to said nozzle; and
wherein said valve is configured to allow a fluid to flow from said base inlet to said insert outlet when said insert is connected to said nozzle.

22. The ligature resistant quick disconnect assembly of claim 21, further comprising:
a second locking tab extending radially outward from said insert locking section; and
wherein said second locking tab is positioned in a second locking recess defined in said nozzle insert opening of said nozzle when said insert is connected to said nozzle.

23. The ligature resistant quick disconnect assembly of claim 21,
wherein said insert includes an insert base and said insert locking section extends from said insert base; and
wherein said insert base has a width that is greater than a width of said insert locking section.

24. The ligature resistant quick disconnect assembly of claim 23, wherein said insert base is in contact with said nozzle when said insert is connected to said nozzle.

25. The ligature resistant quick disconnect assembly of claim 21,
wherein said insert is in contact with said shutoff valve when said insert is connected to said nozzle.

26. The ligature resistant quick disconnect assembly of claim 21, wherein said shutoff valve is translatable within said nozzle valve opening.

27. The ligature resistant quick disconnect assembly of claim 26,
wherein said insert is configured to cause translation of said shutoff valve within said nozzle valve opening when said insert is connected to said nozzle.

28. The ligature resistant quick disconnect assembly of claim 21, wherein said shutoff valve is configured to block flow of said fluid from said base inlet when said insert is disconnected from said nozzle.

29. The ligature resistant quick disconnect assembly of claim 27, wherein said shutoff valve completely prevents flow of fluid from said base inlet when said insert is disconnected from said nozzle.

30. The ligature resistant quick disconnect assembly of claim 21, wherein said insert includes an accessory attachment section, and wherein a hose is attachable at said accessory attachment section of said insert.

31. The ligature resistant quick disconnect assembly of claim 30, wherein said accessory attachment section extends from an insert base of said insert, and wherein said insert base has a width that is greater than a width of said accessory attachment section.

32. The ligature resistant quick disconnect assembly of claim 21, wherein said insert includes an insert inlet, wherein said insert inlet is in fluid communication with said insert outlet.
